(19) United States
(12) Patent Application Publication
(10) Pub. No.: US 2026/0148403 A1
(43) Pub. Date: May 28, 2026

(54) APPARATUS, METHOD, AND SYSTEM FOR PROVIDING MACHINE LEARNING DYNAMIC COMPLEXITY MODELING FOR ADAPTIVE DATA SHARING IN SIMULTANEOUS LOCALIZATION AND MAPPING

(71) Applicant: Nokia Solutions and Networks Oy, Espoo (FI)

(72) Inventors: Jacky CAO, Espoo (FI); Maryam SABZEVARI, Espoo (FI)

(21) Appl. No.: 19/390,138

(22) Filed: Nov. 14, 2025

(30) Foreign Application Priority Data
Nov. 26, 2024 (FI) 20246385

(51) Int. Cl. G06T 7/579; G06T 1/20; G06T 7/246; H04L 43/04

(52) U.S. Cl. CPC G06T 7/579; G06T 1/20; G06T 7/248; H04L 43/04; G06T 2207/20081; G06T 2207/20084

(57) ABSTRACT

An approach is provided for machine learning (ML) dynamic complexity modeling for adaptive data sharing in simultaneous localization and mapping (SLAM). The approach involves, for example, receiving an output of a ML model that performs a keypoints extraction task on image frame data and has an adaptive model complexity capable of an early exit before a final layer of the machine learning model. The approach also involves determining a temporal loss based on differences between features detected in two or more temporally successive image frames, and determining performance metrics of a communication network for the transmitting the output to a server device. The approach further involves determining a loss metric based on the temporal loss and/or the performance metrics, and initiating the early exit of the machine learning model based on the loss metric.

### FIELD

The disclosed subject matter generally relates to using an adaptive machine learning (ML) model for computer vision algorithms which analyze environment data streams (e.g., image frames) for use cases such as extended reality (XR) applications.

### BACKGROUND

Extended reality (XR) systems generally perform the computer vision task of simultaneous localization and mapping (SLAM). Namely, the process of simultaneously creating environment maps and localizing agents within those maps. Incorporating SLAM into XR pipelines is useful as holograms can then be more accurately placed and tracked within the environment. In a client-server XR system, one way to distribute the SLAM components is placing its entirety on a server and have clients transmit images. However, this could end up producing network congestion and degrade the overall XR experience which leads to the challenge of optimizing the client-server data sharing for XR.

### SOME EXAMPLE EMBODIMENTS

Therefore, there is a need for providing machine learning (ML) dynamic complexity modeling for adaptive data sharing in simultaneous localization and mapping (SLAM).

According to one example embodiment, an apparatus comprises means for receiving an output of a machine learning model. The machine learning model performs a keypoints extraction task on image frame data and has an adaptive model complexity capable of an early exit before a final layer of the machine learning model. The apparatus also comprises means for determining a temporal loss based, at least in part, on one or more differences between one or more features detected in two or more temporally successive image frames of the image frame data. The apparatus further comprises means for determining one or more performance metrics of a communication network for transmitting the output to a server device. The apparatus further comprises means for determining a loss metric based on the temporal loss, the one or more performance metrics of the communication network, or a combination thereof. The apparatus further comprises means for initiating the early exit of the machine learning model based, at least in part, on the loss metric.

According to another embodiment, an apparatus comprises at least one processor, and at least one memory storing instructions that, when executed by the at least one processor, cause the apparatus at least to perform receiving an output of a machine learning model. The machine learning model performs a keypoints extraction task on image frame data and has an adaptive model complexity capable of an early exit before a final layer of the machine learning model. The apparatus is also caused to perform determining a temporal loss based, at least in part, on one or more differences between one or more features detected in two or more temporally successive image frames of the image frame data. The apparatus is further caused to perform determining one or more performance metrics of a communication network for transmitting the output to a server device. The apparatus is further caused to perform determining a loss metric based on the temporal loss, the one or more performance metrics of the communication network, or a combination thereof. The apparatus is further caused to perform initiating the early exit of the machine learning model based, at least in part, on the loss metric.

According to another embodiment, a method comprises receiving an output of a machine learning model. The machine learning model performs a keypoints extraction task on image frame data and has an adaptive model complexity capable of an early exit before a final layer of the machine learning model. The method also comprises determining a temporal loss based, at least in part, on one or more differences between one or more features detected in two or more temporally successive image frames of the image frame data. The method further comprises determining one or more performance metrics of a communication network for transmitting the output to a server device. The method further comprises determining a loss metric based on the temporal loss, the one or more performance metrics of the communication network, or a combination thereof. The method further comprises initiating the early exit of the machine learning model based, at least in part, on the loss metric.

According to another embodiment, a computer program comprising instructions which, when executed by an apparatus, cause the apparatus to perform receiving an output of a machine learning model. The machine learning model performs a keypoints extraction task on image frame data and has an adaptive model complexity capable of an early exit before a final layer of the machine learning model. The apparatus is also caused to perform determining a temporal loss based, at least in part, on one or more differences between one or more features detected in two or more temporally successive image frames of the image frame data. The apparatus is further caused to perform determining one or more performance metrics of a communication network for transmitting the output to a server device. The apparatus is further caused to perform determining a loss metric based on the temporal loss, the one or more performance metrics of the communication network, or a combination thereof. The apparatus is further caused to perform initiating the early exit of the machine learning model based, at least in part, on the loss metric.

According to another embodiment, a non-transitory computer-readable storage medium comprising program instructions that, when executed by an apparatus, cause the apparatus to perform receiving an output of a machine learning model. The machine learning model performs a keypoints extraction task on image frame data and has an adaptive model complexity capable of an early exit before a final layer of the machine learning model. The apparatus is also caused to perform determining a temporal loss based, at least in part, on one or more differences between one or more features detected in two or more temporally successive image frames of the image frame data. The apparatus is further caused to perform determining one or more performance metrics of a communication network for transmitting the output to a server device. The apparatus is further caused to perform determining a loss metric based on the temporal loss, the one or more performance metrics of the communication network, or a combination thereof. The apparatus is further caused to perform initiating the early exit of the machine learning model based, at least in part, on the loss metric.

According to one example embodiment, an apparatus comprises circuitry configured to perform receiving an output of a machine learning model. The machine learning model performs a keypoints extraction task on image frame data and has an adaptive model complexity capable of an early exit before a final layer of the machine learning model. The circuitry is also configured to perform determining a temporal loss based, at least in part, on one or more differences between one or more features detected in two or more temporally successive image frames of the image frame data. The circuitry is further configured to perform determining one or more performance metrics of a communication network for transmitting the output to a server device. The circuitry is further configured to perform determining a loss metric based on the temporal loss, the one or more performance metrics of the communication network, or a combination thereof. The circuitry is further configured to perform initiating the early exit of the machine learning model based, at least in part, on the loss metric.

According to a further embodiment, a device comprises at least one processor; and at least one memory including a computer program code for one or more programs, the at least one memory and the computer program code configured to, with the at least one processor, cause the device to perform receiving an output of a machine learning model. The machine learning model performs a keypoints extraction task on image frame data and has an adaptive model complexity capable of an early exit before a final layer of the machine learning model. The device is also caused to perform determining a temporal loss based, at least in part, on one or more differences between one or more features detected in two or more temporally successive image frames of the image frame data. The device is further caused to perform determining one or more performance metrics of a communication network for transmitting the output to a server device. The device is further caused to perform determining a loss metric based on the temporal loss, the one or more performance metrics of the communication network, or a combination thereof. The device is further caused to perform initiating the early exit of the machine learning model based, at least in part, on the loss metric.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of the claims.

According to some aspects, there is provided the subject matter of the independent claims. Some further aspects are defined in the dependent claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The example embodiments of the invention are illustrated by way of examples, and not by way of limitation, in the figures of the accompanying drawings:

FIG. 1 is a diagram of a system capable of providing machine learning (ML) dynamic complexity modeling for adaptive data sharing in simultaneous localization and mapping (SLAM), according to one example embodiment;

FIG. 2 is a diagram of components of the system capable of providing ML dynamic complexity modeling for adaptive data sharing in SLAM, according to one example embodiment;

FIG. 3 is a flowchart of a process for training of ML models for adaptive data sharing in SLAM, according to one example embodiment;

FIG. 4 is a diagram illustrating example time series image data, according to one example embodiment;

FIG. 5 is a diagram illustrating example image segmentation for computing temporal loss, according to example embodiment;

FIG. 6 is a diagram illustrating an example of extracted keypoints and calculated residuals, according to one example embodiment;

FIG. 7 is flowchart of a process for ML model inference for adaptive data sharing in SLAM, according to one example embodiment;

FIG. 8 is a diagram of hardware that can be used to implement example embodiments; and

FIG. 9 is a diagram of a chip set that can be used to implement example embodiments.

### DESCRIPTION OF SOME EMBODIMENTS

Examples of a method, apparatus, and computer program for providing symbiotic autonomous training of machine learning (ML) models, according to one example embodiment, are disclosed in the following. In the following description, for the purposes of explanation, numerous specific details and examples are set forth to provide a thorough understanding of the embodiments of the invention. It is apparent, however, to one skilled in the art that the embodiments of the invention may be practiced without these specific details or with an equivalent arrangement. In other instances, structures and devices are shown in block diagram form to avoid unnecessarily obscuring the embodiments of the invention.

Reference in this specification to “one embodiment”, “one example embodiment”, “an “embodiment”, or “an example embodiment” means that a particular feature, structure, or characteristic described in connection with the embodiment is included in at least one embodiment of the present disclosure. The appearance of the phrase “in one embodiment” or “in one example embodiment” in various places in the specification are not necessarily all referring to the same example embodiment, nor are separate or alternative example embodiments mutually exclusive of other embodiments. In addition, the embodiments described herein are provided by example, and as such, “one embodiment” can also be used synonymously as “one example embodiment.” Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

As used herein, “at least one of the following: <a list of two or more elements>,” “at least one of <a list of two or more elements>,” “<a list of two or more elements> or a combination thereof,” and similar wording, where the list of two or more elements are joined by “and” or “or”, mean at least any one of the elements, or at least any two or more of the elements, or at least all the elements.

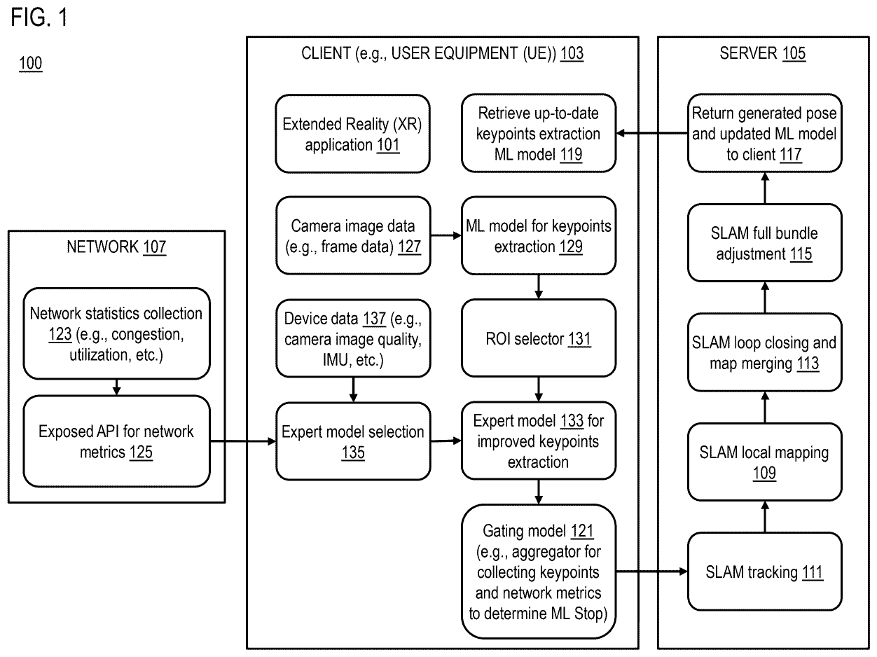

FIG. 1 is a diagram of a system 100 capable of providing ML dynamic complexity modeling for adaptive data sharing in SLAM, according to one example embodiment. Extended reality (XR) applications (e.g., XR application 101 executing a client/user equipment (UE) device 103) enhance the physical world by overlaying user views with virtually drawn holograms and annotations. The computer vision algorithms which analyze environment data streams for the XR applications 101 are generally not executed on-device (e.g., on client/UE 103), since XR applications 101 usually have stringent quality of service (QoS) requirements and user devices 103 have limited computation power. Computation offloading is suitable for overcoming these issues where resource intensive algorithms are moved from user devices (UEs 103) to external nodes with more computation power (e.g., cloud or edge servers such as a server 105) over a communication/data network 107. With computer vision, the images from device cameras need to be transmitted from client (e.g., UE 103) to server (e.g., server 105). However, this transmission could lead to network link saturation, and with a multi-client system, this could create substantial network congestion. Therefore, there is a need to optimize the data sharing in an XR system (e.g., system 100) to ensure that XR applications 101 can meet their requirements while not impacting other users.

In one embodiment, the system 100 which performs the computer vision task of simultaneous localization and mapping (SLAM). Namely, the process of simultaneously creating environment maps (e.g., SLAM local mapping 109) and localizing agents within those maps (e.g., SLAM tracking 111). Incorporating SLAM into XR pipelines is useful as holograms can then be more accurately placed and tracked within the environment. In a client-server XR system (e.g., system 100), one way to distribute the SLAM components (e.g., image processing for keypoint extraction, SLAM local mapping 109, SLAM tracking 111, SLAM loop closing and map merging 113, SLAM full bundle adjustment 115, and returning pose and updated ML models 117) is placing its entirety on a server 105 and have clients/UEs 103 transmit images. However, as stated, this could end up producing network congestion and degrade the overall XR experience which leads to the challenge of optimizing the client-server data sharing for XR.

To address these technical challenges, the system 100 of FIG. 1 introduces a capability to solve the problem of how to execute ML models, such as neural networks (NN), on client-devices 103 to extract keypoint features from images as quickly and efficiently as possible. In one embodiment, after client-side extraction, these keypoints are offloaded to an external server 105 for SLAM processing. Conventional approaches typically uses the entirety of the neural networks (NNs) of ML models for feature extraction, where the ML model could contain many layers which consumes more device energy and takes longer to complete. Furthermore, the model execution occurs agnostically to the happenings of the network 107. Meaning that, a NN could compute results but end up discarding them as the network link between the client 103 and server 105 may be congested and the throughput too low to support real-time data transmission for SLAM processing.

The various embodiments described herein address these technical challenges by using a lightweight ML model deployed on clients 103 to perform keypoints extraction from images (e.g., retrieve up-to-date keypoints extraction ML model from server 105 in process 119). The model is designed to have adaptive model complexity so that not every layer of the NN needs to be executed. By way of example, a “layer” refers to a collection of “nodes” that operate together at a specific depth within a neural network. Examples include an input layer (traditionally the first layer) that contains raw input data with a “node” in the input layer representing each variable of the input, and an output layer (traditionally the final layer) with each node representing one potential output parameter. The layers between the input layer and output layer are referred to as hidden layers each comprising any number of nodes, where each layer “learns” different aspects about the input data by minimizing a loss function. As used herein, an “early exit” refers to stopping the machine learning model at one of the hidden layers before the output layer, and taking the output from the hidden layer at which the machine learning model was stopped.

This early exit achieves the technical effect of reducing overall time needed to finish running the model. At each layer, the model can be stopped and exited from depending on a calculated loss metric (e.g., an early exit). In one embodiment, the system 100 uses a loss value/metric that is calculated for each layer which novelly depends on (1) the loss of the keypoints extraction task, (2) the loss from the features in images, and (3) a penalty based on network latency. Then, the loss can be used during both model training and model inference to stop the model whenever accurate results are obtained (e.g., via a gating model 121 that aggregates keypoints and network metrics to determine at which layer the ML keypoints extraction should stop). The network performance metrics (e.g., latency, congestion, utilization, etc.) can be determined from the network 107 through network statistics collection 123 via, for instance, exposed application programming interfaces (APIs) for network metrics 125.

As shown in FIG. 1, the system 100 relies on the client/UE 103 to capture camera data (also referred to as frame data) 127 using its on-board camera sensors. In one embodiment, this image/frame data 127 can be processed using an initial ML model for keypoints extraction 129 (e.g., a ML model trained for general object recognition). A region of interest (ROI) selector 131 can then determine what areas or segments of the frame data 127 (e.g., delineated by bounding boxes) contain the features or keypoints of interest for SLAM processing. By way of example, keypoints or features of interest used for SLAM processing typically include distinct and recognizable elements within an image, such as corners, edges, and textures. Commonly used keypoints include but are not limited to Harris corners, SIFT (Scale-Invariant Feature Transform) descriptors, and ORB (Oriented FAST and Rotated BRIEF) features, which are resilient to changes in scale, rotation, and illumination, ensuring robust and reliable mapping and localization.

Once the ROI is selected, an expert model 133 for improved keypoints extraction can be used. In comparison to the initial model 129, the expert model 133 can be trained to detect specific features or feature types with more specificity and/or accuracy. The process 135 for selecting an expert model 133 to apply can be based on device data 137 such as but not limited to camera image quality, inertial measurement unit (IMU) readings, etc. The training and inference processes associated with the various embodiments described herein are described in more detail below.

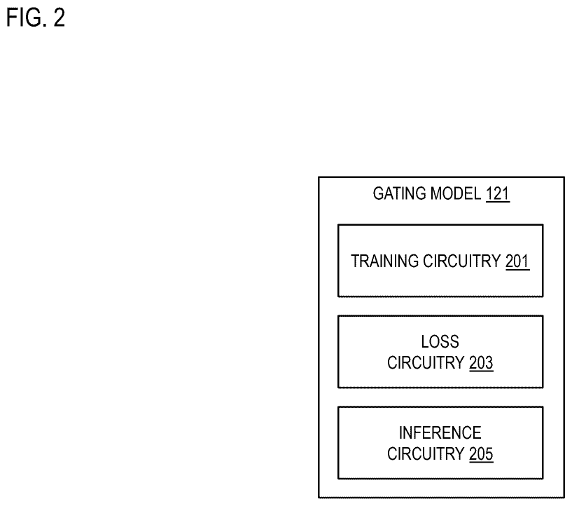

FIG. 2 is a diagram of components of the system 100 capable of providing ML dynamic complexity modeling for adaptive data sharing in SLAM, according to one example embodiment. In one embodiment, the system 100 (e.g., via a gating model 121) performs the functions and methods associated with, and provides means for ML dynamic complexity modeling for adaptive data sharing in SLAM according to the various embodiments described herein. As shown in FIG. 2, the gating model 121 or any other equivalent aggregator module of the system 100 includes: (1) training circuitry 201 for training models for adaptive network layers; (2) loss circuitry 203 for determining loss metrics for stopping the adaptive NN at specific layers based on feature and network loss during training and/or inference; and (3) inference circuitry 205 for applying the adaptive network for keypoints extraction, e.g., to support SLAM processing. It is contemplated that the functions of the components/circuitry of the system 100 described above may be combined or performed by other components or means of equivalent functionality. The above presented components comprise means for performing the various embodiments and can be implemented in a circuitry, a hardware, a firmware, a software, a chip set, or in any combination thereof. The functions of the components of the gating model 121 and/or aggregator module are described in more detail below.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular telecom network device, or other computing or network device. In another embodiment, one or more of the components of the system 100 may be implemented as a cloud-based service, local service, native application, or in any combination thereof.

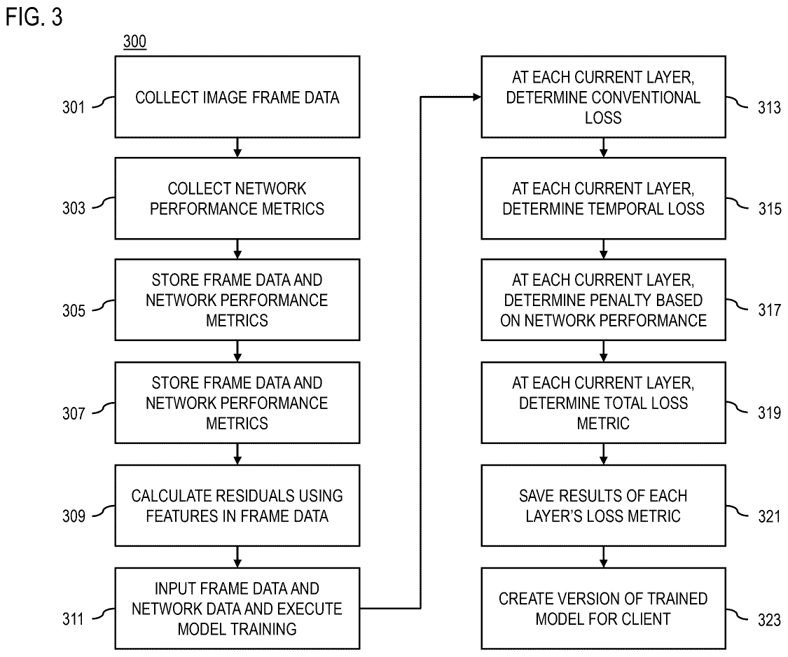

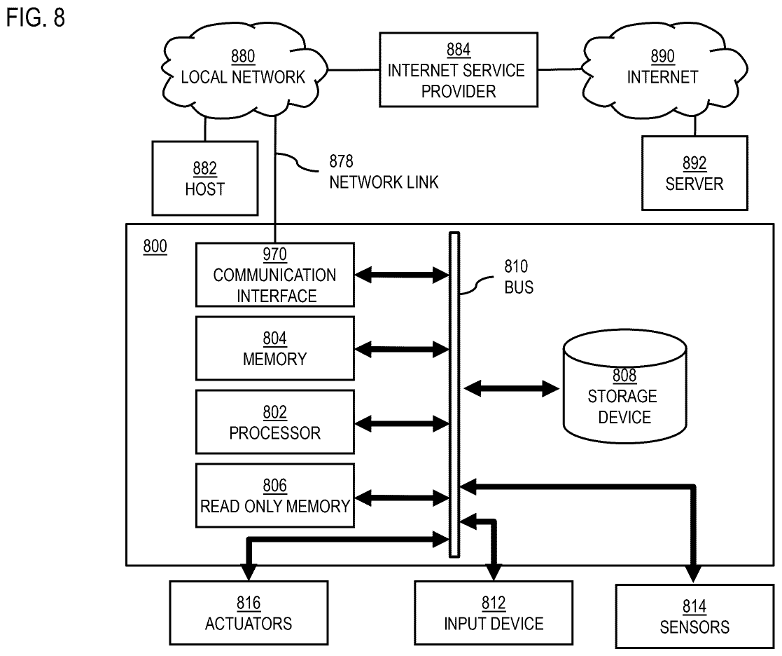

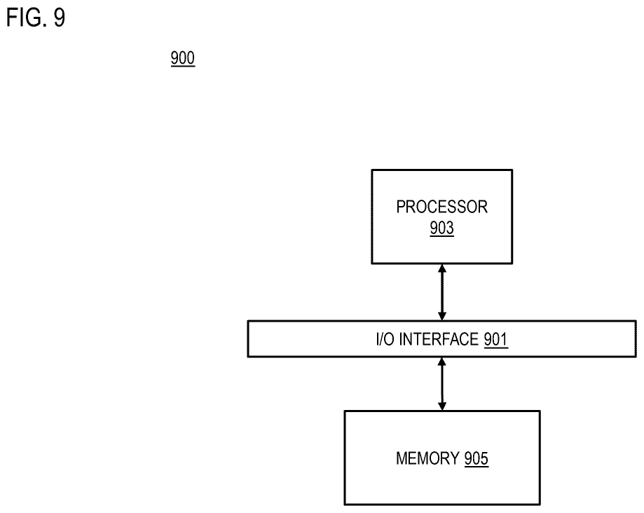

FIG. 3 is a flowchart of a process for training of ML models for adaptive data sharing in SLAM, according to one example embodiment. In one example, the gating model 121/aggregator module and/or any of its components/circuitry may perform one or more portions of a process 300 and may be implemented in/by various means, for instance, one or more chip sets including a processor and a memory as shown in FIG. 8 or 9 or in a circuitry, hardware, firmware, software, or in any combination thereof. In one example embodiment, the circuitry includes but is not limited to any component discussed with respect to FIG. 2. As such, the gating model 121/aggregator module and/or any associated component, apparatus, device, circuitry, system, computer program product, method, and/or non-transitory computer readable medium, or any combination thereof, can provide means for accomplishing various parts of the process 300, as well as means for accomplishing embodiments of other processes described herein. Although the process 300 is illustrated and described as a sequence of steps, it is contemplated that various embodiments of the process 300 may be performed in any order or combination and need not include all of the illustrated steps.

In summary, the process 300 is based on a lightweight ML model which can exit from any of its layers according to a calculated loss value. This model is referred to herein as an “expert model” due to its function in extracting more accurate features (e.g., keypoints) from images which are then required for SLAM's processing pipeline. FIG. 1 presents an example of the XR system which uses SLAM in combination with the various embodiments described herein. Most of the SLAM pipeline is offloaded to a server 105, and the system 100 only runs the keypoints extraction phase of SLAM on the client 103. This is so that instead of transmitting images from the client 103 to the server 105, a smaller amount of data (e.g., relative to sending raw image data) can be sent in the form of matrices of keypoints data.

This client-based expert model can be trained offline on a server with the necessary computation power and training datasets to ensure that accurate loss values can be obtained according to the various embodiments of process 300.

In one embodiment, the trained model is then deployed on client devices 103, i.e., between the tasks of an initial ML model which extracts general keypoints and an aggregator which collects the improved keypoints from the expert model as well as the data related to obtaining them (e.g., the number of layers of the model processed, the network metrics, and the loss values-more details are specified later). These are transmitted to the server 105 so the model can be updated through re-training or fine-tuning at a later stage, and this updated model can be disseminated back to the clients 103.

In one embodiment, at least two data inputs are used for the expert model: (1) timeseries image frame data; and (2) timeseries network metric data covering same time period as the image frame data.

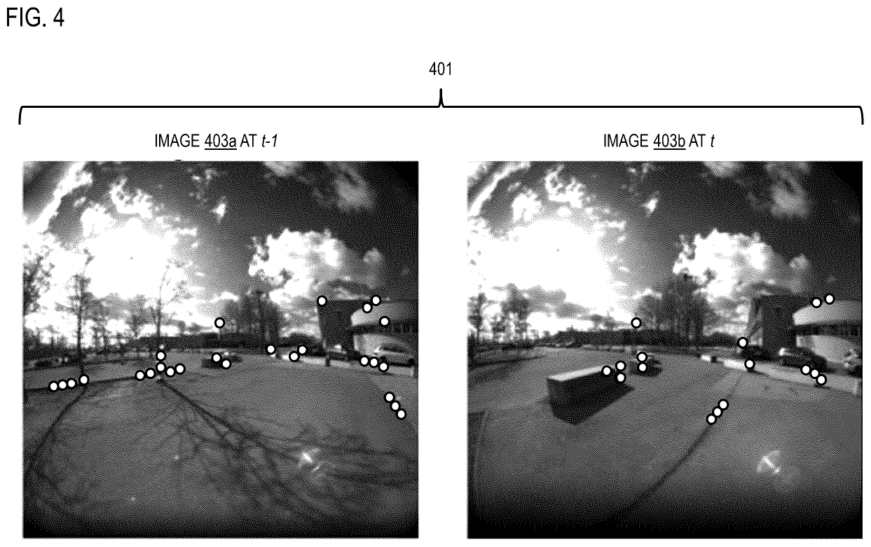

Accordingly, at step 301, the process 300 begins by gathering image frame data 127, which may include visual inputs or video data for analysis. This data forms the basis for subsequent feature extraction. The image frame data 127 (e.g., the first input) is a sequential time series set of image frames taken from client/UE devices 103 (e.g., from a world-facing camera on a smartphone, head mounted device (HMD), etc.). FIG. 4 illustrates this where the frame data 401 includes the original images that were captured by the client, and an initial set of frames keypoint features captured by a general keypoints extraction algorithm. In this example, the frame data 401 includes a first image frame 403a captured at time t−1 and a second image frame 403b captured at time t. The extracted keypoints in each image frame 403a and 403b is represented by a white dot.

The second input is a set of scalar or multidimensional timeseries data from the network which corresponds to the same time-period and time steps as the client-captured frame data 401. Accordingly, at step 303, metrics related to network performance, such as bandwidth, latency, or throughput, are collected (e.g., via exposed APIs or equivalent). These metrics provide contextual information about the operational environment of the client 103 and server 105 within the network 107. In one embodiment, the various embodiments of process 300 assumes that the network has exposed APIs or a method which allows clients 103, servers 105, and other non-network nodes to access metrics collected by the network 107. For example, metrics can include but is not limited to congestion levels or throughput of the network at base stations. In one embodiment, the network performance metric data can be made available through a publish-subscribe interface, where a non-network node can subscribe to a particular network metric data stream and receive the requested data at pre-defined data intervals.

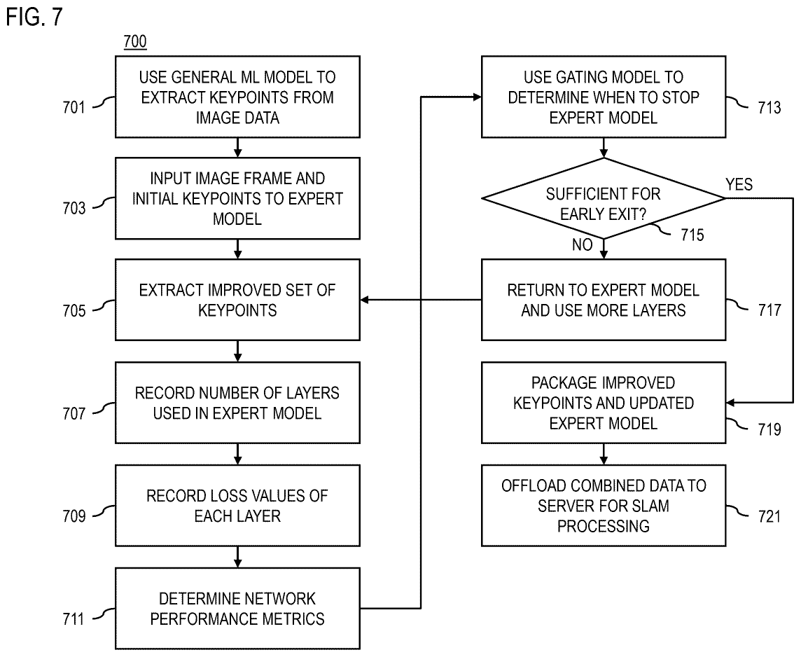

At steps 305 and 307, the image frame data and/or network performance metrics are stored in a structured database or memory (e.g., of a ML training server) for further analysis. This enables accessibility and integration for downstream processing. As previously discussed, the process 300 considers both the model training (e.g., according to the process 300 herein) and model inference (e.g., as discussed further below with respect to process 700 of FIG. 7. In one embodiment, the expert model is a neural network consisting of stacked layers where the early layers could be sufficient to address the needs of simple tasks or to perform coarse predictions, and the later layers could focus on complex regions and areas which have variance or where earlier layers failed to make sufficient keypoint predictions.

Table 1 below illustrates code describing the structure of this expert model.

```
TABLE 1
def vgg_block(
  inputs,
  filters,
  kernel_size,
  name,
  data_format,
  training=False,
  batch_normalization=True,
  kernel_reg=0.0,
  **params
):
  with tf.variable_scope(name, reuse=tf.AUTO_REUSE):
    x = tfl.conv2d(
      inputs,
      filters,
      kernel_size,
      name=“conv”,
      kernel_regularizer=tf.contrib.layers.l2_regularizer(kernel_reg),
      data_format=data_format,
      **params
    )
    if batch_normalization:
      x = tfl.batch_normalization(
        x,
        training=training,
        name=“bn”,
        fused=True,
        axis=1 if data_format == “channels_first” else −1,
      )
  return x
def vgg_backbone(inputs, return_layer=None, **config):
  params_conv = {
    “padding”: “SAME”,
    “data_format”: config[“data_format”],
    “activation”: tf.nn.relu,
    “batch_normalization”: True,
    “training”: config[“training”],
    “kernel_reg”: config.get(“kernel_reg”, 0.0),
  }
  params_pool = {“padding”: “SAME”, “data_format”:
  config[“data_format”]}
  with tf.variable_scope(“vgg”, reuse=tf.AUTO_REUSE):
    x = vgg_block(inputs, 64, 3, “conv1_1”, **params_conv)
    x = vgg_block(x, 64, 3, “conv1_2”, **params_conv)
    x = tfl.max_pooling2d(x, 2, 2, name=“pool1”, **params_pool)
    # Model exit condition to be finalized
    if return_layer == “pool1”:
      return x
    x = vgg_block(x, 64, 3, “conv2_1”, **params_conv)
    x = vgg_block(x, 64, 3, “conv2_2”, **params_conv)
    x = tfl.max_pooling2d(x, 2, 2, name=“pool2”, **params_pool)
    # Model exit condition to be finalized
    if return_layer == “pool2”:
      return x
    x = vgg_block(x, 128, 3, “conv3_1”, **params_conv)
    x = vgg_block(x, 128, 3, “conv3_2”, **params_conv)
    x = tfl.max_pooling2d(x, 2, 2, name=“pool3”, **params_pool)
    # Model exit condition to be finalized
    if return_layer == “pool3”:
      return x
    x = vgg_block(x, 128, 3, “conv4_1”, **params_conv)
    x = vgg_block(x, 128, 3, “conv4_2”, **params_conv)
  return x
```

By way of example, the code illustrated in Table 1 implements components of a VGG-like convolutional neural network (CNN) architecture in TensorFlow. It consists of two primary functions: ‘vgg_block’ and ‘vgg_backbone’. The ‘vgg_block’ function defines a single convolutional block, which encapsulates a convolutional layer followed optionally by batch normalization. The function takes inputs including the data tensor, the number of filters for the convolution, kernel size, layer name, data format (e.g., “channels_first” or “channels_last”), and other optional parameters like training mode and L2 kernel regularization. Within a variable scope identified by the block's name, it applies a 2D convolution operation using ‘tfl.conv2d’. If batch normalization is enabled, it applies ‘tfl.batch_normalization’ to the output of the convolution, adapting the axis for the data format. The processed tensor is returned.

The ‘vgg_backbone’ function constructs the full backbone of the network by stacking multiple ‘vgg_block’ components with pooling layers interspersed between them. It begins by defining shared configuration parameters for convolutional (‘params_conv’) and pooling (‘params_pool’) layers. Within a variable scope named “vgg”, the function creates a sequence of convolutional blocks, each followed by a max-pooling operation (‘tfl.max_pooling2d’) that reduces spatial dimensions. The network supports early exits via the ‘return_layer’ parameter, allowing the output to be extracted after specific pooling layers (e.g., ‘pool1’, ‘pool2’, or ‘pool3’) for modularity. This modular exit condition is useful for feature extraction at intermediate stages of the network (e.g., after each layer or block of layers). After completing the designated convolution and pooling stages, the final processed tensor is returned.

At step 309, features extracted from the image frame data are analyzed to calculate residuals. These residuals quantify differences or anomalies and assist in refining the model, and represent the differences between observed values and predicted values made by the model (e.g., based on the collected training data).

At step 311, the image and network data are combined and input into a machine learning or statistical model for training the ML model. The training process involves iterative adjustments based on predefined algorithms.

At steps 313, 315, 317, and 319, at each layer of the model, various loss components are calculated: (1) Conventional Loss: Measures deviations between predicted and actual outcomes (e.g., αLₜₐₛₖ, where α is a coefficient determined during training); (2) Temporal Loss: Evaluates consistency across time-related data sequences (e.g., βLₜₑₘₚₒᵣₐₗ, where β is a coefficient determined during training); (3) Penalty Based on Network Performance: Applies adjustments based on network constraints or inefficiencies (e.g., γp(d, c), where γ is a coefficient determined during training); and (4) Total Loss Metric: Aggregates all loss components to assess overall model performance (Lₜₒₜₐₗ=αLₜₐₛₖ+βLₜₑₘₚₒᵣₐₗ+γp(d, c).

In one embodiment, the task loss Lₜₐₛₖ is the conventional loss of the keypoints extraction model, namely, the difference between the generated predicted values and the actual values.

The temporal loss Lₜₑₘₚₒᵣₐₗ is the loss based on the extracted frame features from the client data. A temporal residuals value can be used, which is the distance (e.g., Euclidean or any equivalent measure of distance or difference) between the features of two sequential frames in time. The frame features are suggested to be the keypoints, but could also be the feature maps, pixel values, or other ways to represent the frames' features. In other words, the temporal loss is used to cause the machine learning model to learn based on the one or more differences in the two or more successive image frames during training.

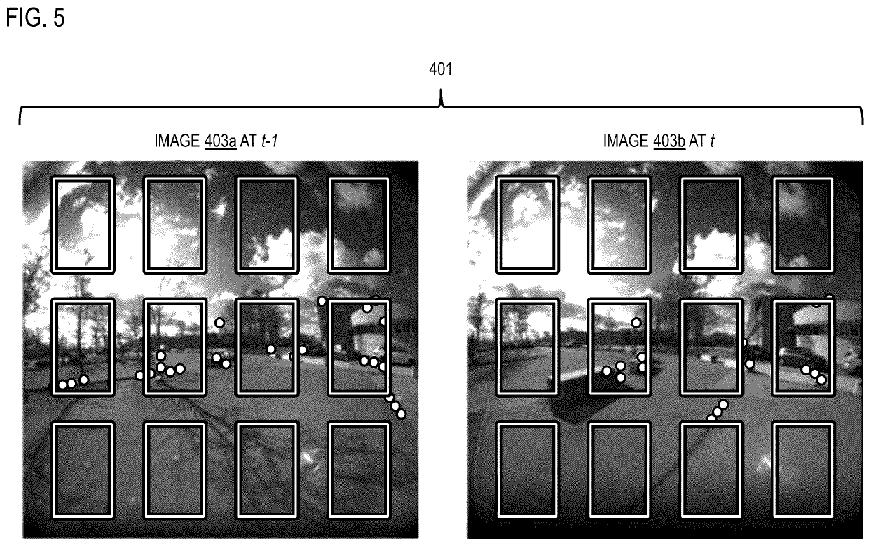

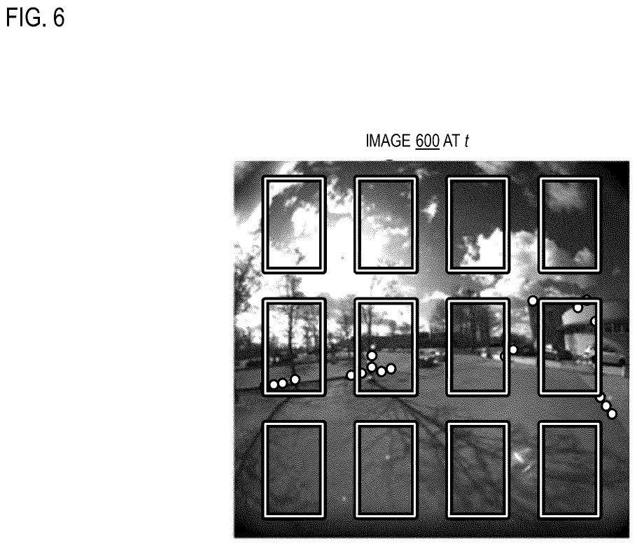

In one embodiment, to compare the features between the frames, the same areas could always be segmented to be compared against. FIG. 5 illustrates one example of this segmentation with respect to the example image frame data 401 of FIG. 4, where the same pattern of segmentation is applied to each frame 403a and 403b (e.g., segmentation pattern indicated by white rectangles). Then, the keypoints extracted from each frame can be used to calculate the residuals as shown in image frame 600 of FIG. 6 which shows the keypoint differences between segmented image frames 403a and 403b of FIG. 5.

Each segment could be treated separately where the loss is computed per segment, meaning that different models could be adapted for different segments based on calculated losses. This would be particularly useful in scenarios where all segments may not contain relevant objects or information to extract keypoints from. For example, the sky could have limited texture and edges for the model to extract features from, therefore, less layers of an extraction model would be needed to be executed when compared to the more complex regions of the foreground.

At step 321, the loss results for each layer are saved to track model optimization progress. For example, in the training phase, the temporal loss is calculated as follows. (1) During the forward pass of the model training, the input is passed through the network, layer-by-layer, and at each layer, the feature maps are computed for the two input frames. (2) The feature differences are then computed at each layer. (3) The dynamic weights are calculated based on a threshold which defines when feature differences are considered large, and a scaling factor which controls sensitivity. (4) A dynamic loss is calculated as a weighted sum of the layer-wise losses. (5) During model back-propagation, the total dynamic loss is back-propagated through the entire network, and the network learns not only to minimize the overall loss, but to also adjust the dynamic weights so deeper layers are used more effectively when needed. (6) The network parameters are updated using an optimizer (e.g., stochastic gradient descent, Adam, etc.) based on the gradient of the dynamic loss. (7) Finally, the process is repeated for all training batches and epochs.

By training the model with such a loss metric, the system 100 can then derive the loss values for each layer which coincides with the given input frames and network conditions. In this way, when the model is finally trained and ready to be used for inference, the model can effectively adapt to the environment conditions and reduce the amount of computation needed to achieve good predictions. For example, this portion of the training process is referred to as “fine-tuning” the machine learning model to function with early exits (e.g., an exit from a layer other than the final output layer). In embodiment, during the fine-tuning process, the system 100 takes the machine learning model and freezes the model parameters of the previous layers up to the first early exit layer. By way of example, “freezing” refers to fixing the weights in those layers up to the first early exit layer, so that they do not change. Then, the earlier exit layer is fine-tuned along with the full model loss (e.g., including the temporal loss) by allowing the layer model parameters (e.g., weights) of the early exit layers to be adjusted by training data in response to back propagation based on the full model loss. This fine-tuning process is repeated for all the early exit layers (e.g., at each subsequent layer or block of layers) of the machine learning model up to the final output layer to fine them. In this way, the trained machine learning model is fined tuned so that during inference, it will exit one at any of the early exit layers or proceed until the full model exit based on the difference of the sequential image frames (e.g., based on the temporal loss).

At step 323, once training is complete, a binary/executable version of the model is created, optimized, and packaged for deployment to the client. For example, this can involve one or more of the following:

(1) Model Optimization: The model is optimized for performance. Techniques such as quantization, pruning, and batching are applied to reduce model size and increase inference speed without significant loss of accuracy.

(2) Serialization: The trained model parameters and architecture are serialized into a binary format. This often involves exporting to a format such as TensorFlow SavedModel or ONNX (Open Neural Network Exchange).

(3) Packaging: The serialized model is then packaged into an executable format. This may include bundling the model with necessary runtime libraries and dependencies, creating a Docker container, or compiling into machine code using tools like TensorFlow Lite for mobile or embedded deployments.

(5) Deployment: The final package is deployed to the client's infrastructure, which could include cloud servers, edge devices, or mobile devices. Deployment scripts and orchestration tools are often used to automate this process.

FIG. 7 is flowchart of a process for ML model inference for adaptive data sharing in SLAM, according to one example embodiment. In one example, the gating model 121/aggregator module and/or any of its components/circuitry may perform one or more portions of a process 700 and may be implemented in/by various means, for instance, one or more chip sets including a processor and a memory as shown in FIG. 8 or 9 or in a circuitry, hardware, firmware, software, or in any combination thereof. In one example embodiment, the circuitry includes but is not limited to any component discussed with respect to FIG. 2. As such, the gating model 121/aggregator module and/or any associated component, apparatus, device, circuitry, system, computer program product, method, and/or non-transitory computer readable medium, or any combination thereof, can provide means for accomplishing various parts of the process 700, as well as means for accomplishing embodiments of other processes described herein. Although the process 700 is illustrated and described as a sequence of steps, it is contemplated that various embodiments of the process 700 may be performed in any order or combination and need not include all of the illustrated steps.

The process 700 is based on ML models that have been trained for keypoint extraction using an adaptive model as described with respect to the process 300 of FIG. 4.

At step 701, the process 700 begins with a general ML model, deployed on the client device 103, extracting an initial set of keypoints from images captured by the client device 103. For example, these keypoints are based on features detected in image frame data that can be used for SLAM processing. As used herein, a general ML model is one that is trained to detect a broad range or features or objects that can be used a keypoints. In contrast, an expert model can be specialized or trained to detect specific types of objects or features.

At step 703, the extracted initial keypoints, along with the corresponding image data, are provided as input to an expert model. This expert model is designed to refine the quality of the keypoints, leveraging advanced or specialize model training specific to certain features. The expert model has also been fine-tuned to support an early exit of the model according to the various embodiments described herein (e.g., by supporting dynamic complexity modeling whereby more layers of the expert models are used if needed based on computed loss such as temporal loss).

At step 705, the expert model processes the input data and extracts an improved set of keypoints. For example, improved may include but is not limited to greater accuracy of classification and/or greater precision in localization of the keypoints in the image data.

At step 707, the number of layers utilized within the expert model to produce the refined keypoints is logged. The number can be used as input to the gating model to determine at what layer of the expert model the inference task should be stopped.

At step 709, the loss values corresponding to each layer of the expert model are recorded as an input parameter for determining at what layer to stop model inference.

At step 711, the client device 103 subscribes to network metrics, such as network congestion levels, latency, utilization, etc. This information is continuously received and can be temporally matched to the input image frame data to determine network performance at the time image frame data is collected and the current capabilities of the network 107 available to transmit SLAM related data from the client 103 to the server 105 for real-time (or substantially real-time) SLAM processing.

At step 713, the recorded data, including the number of layers used, the corresponding loss values, and the network metrics, are fed into a gating model. This gating model evaluates whether further processing is required or if the current results are sufficient.

At step 715, the gating model makes a determination based on the provided inputs. If the data indicates that the ongoing inference is sufficient to meet performance requirements, the system initiates an early exit (e.g., stops inference at the current layer before a final layer of the expert model) and proceeds to the next step 719. Otherwise, the process returns to the expert model and uses more layers of the model (at step 717), and the expert model continues processing by utilizing additional layers (returning to step 705).

In comparison to the training phase, during inference, the dynamic weights are used to adaptively decide the depth of the network, where the goal is to stop the inference early when the feature differences are small enough, therefore, reducing the computation time for simple inputs. In other words, in one embodiment, the temporal loss is used to determine an early exit from the machine learning model during inference.

In one embodiment of the process 700, the steps of the inference are as follows:

(1) In the model forward pass, the input is passed through each layer of the network sequentially.

(2) At each of these layers, the feature differences are computed.

(3) The dynamic weights are then calculated.

(4) An early exit check is performed, i.e., comparing the dynamic weight to a threshold, and if the dynamic weight is less than this threshold, this indicates that further layers of the model may not add significant value, and the forward pass of the model can be terminated.

(5) For any layer, if the dynamic weight is less than the threshold and the forward pass is terminated, the output is returned from the current layer. Alternatively, if the dynamic weight is greater than the threshold, then the forward pass through all the layers is completed.

(6) The results are then returned from the layer where the early exit occurred, or from the final layer if no early exit happened.

The temporal loss, Lₜₑₘₚₒᵣₐₗ, is defined as:

$${L}_{temporal} = {\sum }_{i} {ω}_{i} {L}_{i}$$

where ωᵢ=σ(aΔᵢ−τ), i.e., the dynamic weight, where σ is the sigmoid function, a is the scaling factor that controls the sensitivity, Δᵢ=∥Fᵢ(x₁)−Fᵢ(x₂)∥₂ is the feature difference at each layer, and τ is the threshold that defines when feature differences are considered large; and Lᵢ is the loss (e.g., mean squared error or cross-entropy) at layer i.

In one embodiment, another component of the summarized loss is the penalty metric based on network-derived statistics, e.g., the latency, and the number of layers in the model. As mentioned, the network input data should be in the form of a timeseries which corresponds to the received client frame data. The penalty uses the network metric as an input in a defined function, for example, a function of latency. This function is then scaled by the current number of layers processed, i.e., which layer this loss calculation is occurring. In this way, the model is incentivized to minimize the number of layers which are processed to ensure that the penalty and overall loss does not balloon to a significantly large value.

The penalty, p(d, c), is defined as follows:

$$p ( d , c ) = λ ( c ) {d}^{2}$$

where λ(c) is the function of the network metric (e.g., latency), and d is the number of layers processed.

In summary, for model inference at runtime, the following can be collected: the number of layers of the model which has been processed, the network metrics, and the loss values. These are then input into a separate simple gating model which can stop the on-going inference, or they can be used to calculate a value which is compared against a defined threshold which is used to stop the inference.

At step 719, upon determining that the inference can stop, the improved keypoints and the updated expert model are packaged together. This ensures that the results are prepared for further utilization in downstream processes such as SLAM processing.

At step 721, the final packaged data, comprising the improved keypoints and the expert model, is offloaded to the server 103. This server facilitates further processing within the SLAM or XR pipeline.

By way of example, the various embodiments described herein have several use-cases in XR. For example, entertainment, gaming, eCommerce, education, and others. With the use-cases of entertainment and gaming, content is traditionally fixed to 2-dimensional displays. XR content can enhance users' experience by allowing them to consume and interact with immersive 3-dimensional content. With sports viewing, with several users in a living room, each with their own XR device, who are all watching the same match of a sport. During the game, there are video, audio, and XR content streams of the action, e.g., from different angles, from the perspective of a referee or player, etc. To enable a collaborative and engaging experience, the XR content in particular, e.g., holograms, should be synchronized to appear in the same locations for each user. This requires SLAM and its ability to map environments and localize content and users within that. Furthermore, there is the stringent requirement of near real-time viewing. Therefore, the various embodiments described herein can support this use-case and more, through its reduction in the amount of data transmitted between clients and servers, and its ability to adapt to evolving network conditions.

Returning to FIG. 1, in one example, the components of the system 100 may communicate over one or more communications networks 107 that includes one or more networks such as a data network, a wireless network, a telephony network, or any combination thereof. It is contemplated that the communications network 107 may be any local area network (LAN), metropolitan area network (MAN), wide area network (WAN), a public data network (e.g., the Internet), short range wireless communications network, or any other suitable packet-switched network, such as a commercially owned, proprietary packet-switched network, e.g., a proprietary cable or fiber-optic network, and the like, or any combination thereof. In addition, the communications network 107 may be, for example, a cellular telecom network and may employ various technologies including enhanced data rates for global evolution (EDGE), general packet radio service (GPRS), global system for mobile communications (GSM), Internet protocol multimedia subsystem (IMS), universal mobile telecommunications system (UMTS), worldwide interoperability for microwave access (WiMAX), Long Term Evolution (LTE) networks, 5G/3GPP (fifth-generation technology standard for broadband cellular networks/3^{rd} Generation Partnership Project) or any further generation, code division multiple access (CDMA), wideband code division multiple access (WCDMA), wireless fidelity (Wi-Fi), wireless LAN (WLAN), Bluetooth®, UWB (Ultra-wideband), Internet Protocol (IP) data casting, satellite, mobile ad-hoc network (MANET), and the like, or any combination thereof.

In one example, the system 100 or any of its components may be a platform with multiple interconnected components (e.g., a distributed framework). The system 100 and/or any of its components may include multiple servers, intelligent networking devices, computing devices, components, and corresponding software for spatial-temporal authentication. In addition, it is noted that the system 100 or any of its components may be a separate entity, a part of the one or more services, a part of a services platform, or included within other devices, or divided between any other components.

By way of example, the components of the system 100 can communicate with each other and other components external to the system 100 using well known, new or still developing protocols. In this context, a protocol includes a set of rules defining how the network nodes, e.g. the components of the system 100, within the communications network interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically affected by exchanging discrete packets of data. The packets typically comprise (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

The processes described herein for providing ML dynamic complexity modeling for adaptive data sharing in SLAM may be advantageously implemented via software, hardware (e.g., general processor, memory, input/output interface, etc.), firmware, circuitry, or a combination thereof. Such exemplary hardware for performing the described functions is detailed below.

FIG. 8 illustrates an example computer system 800 upon which embodiments of the invention as described with the processes described herein may be implemented. The computer system 800 is programmed (e.g., via computer program code or instructions) to provide ML dynamic complexity modeling for adaptive data sharing in SLAM as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 810 includes one or more parallel conductors of information so that information is transferred quickly among devices coupled to the bus 810. One or more processors 802 for processing information are coupled with the bus 810.

A processor 802 performs a set of operations on information as specified by computer program code related to providing ML dynamic complexity modeling for adaptive data sharing in SLAM. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations includes bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

The computer system 800 also includes a memory 804 coupled to bus 810. The memory 804, such as a random access memory (RAM) or other dynamic storage device, stores information including processor instructions for providing ML dynamic complexity modeling for adaptive data sharing in SLAM. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for providing ML dynamic complexity modeling for adaptive data sharing in SLAM, is provided to the bus 810 for use by the processor from an external input device 812, such as a keyboard containing alphanumeric keys operated by a human user, or one or more sensors. In one embodiment, the computer system 800 includes or otherwise has access to one or more sensors 814 which detect conditions in its vicinity and transforms those detections into physical expression compatible with the measurable phenomenon used to represent information in the computer system 800. Examples of sensors 814 include but are not limited to cameras, Lidar, positioning sensors, gyroscopes, accelerometers, and/or the like. Other external devices coupled to bus 810, include one or more actuators 816. By way of example, an actuator is a device that converts electrical signals (e.g., control signals) into physical actions, such as movement, rotation, or force. In a mobile robot or equivalent drivetrain, an actuator 816 can be used to control the wheels that enable the robot to perform various maneuvers. For example, an actuator 816 can regulate the speed and direction of the wheels. Actuators 816 can be powered by different sources, such as but not limited to electricity, pneumatic pressure, or hydraulic fluid. Some examples of actuators 816 include but are not limited to motors, solenoids, cylinders, and servos. In some embodiments, for example, in embodiments in which the computer system 800 performs all functions automatically without human input, one or more of external input device 812, display device 814 and pointing device 816 is omitted. In various embodiments, the computer system 800 is further connected via the bus 810 to a one or more camera device, flash device or Lidar device.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general, the coupling is with a network link 878 that is connected to a local network 880 to which a variety of external devices with their own processors are connected. In certain embodiments, the communications interface 870 enables connection to the communications network 107 for providing ML dynamic complexity modeling for adaptive data sharing in SLAM.

The term computer-readable medium is used herein to refer to any medium that participates in providing information to processor 802, including instructions for execution. Such a medium may take many forms, including, but not limited to, non-volatile media, volatile media and transmission media. Non-volatile media include, for example, optical or magnetic disks, such as storage device 808. Volatile media include, for example, dynamic memory 804. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, any solid state medium, any magnetic medium, any optical medium, any physical medium, a RAM, any other memory chip, a carrier wave, or any other medium from which a computer can read.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communications network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of the system 100 can be deployed in various configurations within other computer systems, e.g., host 882 and server 892.

FIG. 9 illustrates a chip set 900 upon which embodiments of the invention, for example, the components of system 100 may be implemented. The chip set 900 is programmed to provide ML dynamic complexity modeling for adaptive data sharing in SLAM as described herein. By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 900 includes a communication mechanism such as a input/output (I/O) interface 901 for passing information among the components of the chip set 900 and to external devices (e.g., sensors and/or actuators of a robot, transmitters/receivers for signaling a vehicle/robot/drivetrain or component thereof, etc.). A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. Other specialized components to aid in performing the inventive functions described herein include one or more field programmable gate arrays (FPGA) (not shown), one or more controllers (not shown), or one or more other special-purpose computer chips.

The processor 903 and accompanying components have connectivity to the memory 905 via the I/O interface 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to provide ML dynamic complexity modeling for adaptive data sharing in SLAM. The memory 905 also stores the data associated with or generated by the execution of the inventive steps.

What is claimed is:

1. An apparatus comprising:
at least one processor; and
at least one memory storing instructions that, when executed by the at least one processor, cause the apparatus at least to perform:
receiving an output of a machine learning model, wherein the machine learning model performs a keypoints extraction task on image frame data and has an adaptive model complexity capable of an early exit before a final layer of the machine learning model;
determining a temporal loss based, at least in part, on one or more differences between one or more features detected in two or more temporally successive image frames of the image frame data;
determining one or more performance metrics of a communication network for transmitting the output to a server device;
determining a loss metric based on the temporal loss, the one or more performance metrics of the communication network, or a combination thereof; and
initiating the early exit of the machine learning model based, at least in part, on the loss metric.

2. The apparatus of claim 1, wherein the temporal loss is used to cause the machine learning model to learn based on the one or more differences in the two or more successive image frames during training.

3. The apparatus of claim 1, wherein the temporal loss is used to determine the early exit from the machine learning model during inference.

4. The apparatus of claim 3, wherein the machine learning model is fine-tuned for the early exit during training by freezing the plurality of model parameters of the machine learning model up to an early exit layer of the machine learning model and by adjusting a plurality of layer model parameters for the early exit layer along with a full loss including the temporal loss.

5. The apparatus of claim 1, wherein the instructions, when executed by the at least one processor, further cause the apparatus to perform:
determining a loss of the keypoints extraction task,
wherein the loss metric is determined further based, at least in part, on the loss of the keypoints extraction task.

6. The apparatus of claim 1, wherein the output is processed using a simultaneous localization and mapping (SLAM) processing pipeline to localize, to map, or a combination thereof a device associated with the plurality of images.

7. The apparatus of claim 1, wherein the one or more differences is based, at least in part, on a distance between the one or more features detected in the two or more temporally successive image frames.

8. The apparatus of claim 1, wherein the one or more features are detected from a same image area segment from each of the two or more temporally successive image frames.

9. The apparatus of claim 1, wherein the instructions, when executed by the at least one processor, further cause the apparatus to perform:
determining a penalty metric based on the one or more performance metrics of the communication network,
wherein the loss metric is determined further based, at least in part, on the penalty metric.

10. The apparatus of claim 9, the one or more performance metrics include a network latency.

11. The apparatus of claim 9, wherein the penalty metric is scaled based on a number of layers processed by the machine learning model.

12. A method comprising:
receiving an output of a machine learning model, wherein the machine learning model performs a keypoints extraction task on image frame data and has an adaptive model complexity capable of an early exit before a final layer of the machine learning model;
determining a temporal loss based, at least in part, on one or more differences between one or more features detected in two or more temporally successive image frames of the image frame data;
determining one or more performance metrics of a communication network for transmitting the output to a server device;
determining a loss metric based on the temporal loss, the one or more performance metrics of the communication network, or a combination thereof; and
initiating the early exit of the machine learning model based, at least in part, on the loss metric.

13. The method of claim 12, wherein the temporal loss is used to cause the machine learning model to learn based on the one or more differences in the two or more successive image frames during training.

14. The method of claim 12, wherein the temporal loss is used to determine the early exit from the machine learning model during inference.

15. The method of claim 12, wherein the machine learning model is fine-tuned for the early exit during training by freezing the plurality of model parameters of the machine learning model up to an early exit layer of the machine learning model and by adjusting a plurality of layer model parameters for the early exit layer along with a full loss including the temporal loss.

16. The method of claim 12, further comprising:
determining a loss of the keypoints extraction task,
wherein the loss metric is determined further based, at least in part, on the loss of the keypoints extraction task.

17. The method of claim 12, wherein the output is processed using a simultaneous localization and mapping (SLAM) processing pipeline to localize, to map, or a combination thereof a device associated with the plurality of images.

18. The method of claim 12, wherein the one or more differences is based, at least in part, on a distance between the one or more features detected in the two or more temporally successive image frames.

19. The method of claim 12, wherein the one or more features are detected from a same image area segment from each of the two or more temporally successive image frames.

20. A non-transitory computer readable medium comprising instructions, when executed by an apparatus, cause the apparatus to perform:
receiving an output of a machine learning model, wherein the machine learning model performs a keypoints extraction task on image frame data and has an adaptive model complexity capable of an early exit before a final layer of the machine learning model;
determining a temporal loss based, at least in part, on one or more differences between one or more features detected in two or more temporally successive image frames of the image frame data;
determining one or more performance metrics of a communication network for transmitting the output to a server device;
determining a loss metric based on the temporal loss, the one or more performance metrics of the communication network, or a combination thereof; and
initiating the early exit of the machine learning model based, at least in part, on the loss metric.
